(19) United States
(12) Patent Application Publication
(10) Pub. No.: US 2017/0004617 A1
(43) Pub. Date: Jan. 5, 2017

(54) ELECTRONIC DEVICE AND MEHOD FOR CAPTURING MULTI-ASPECT IMAGES USING THE ELECTRONIC DEVICE

(71) Applicant: HON HAI PRECISION INDUSTRY CO., LTD, New Taipei (TW)

(72) Inventors: HOU-HSIEN LEE, New Taipei (TW); CHANG-JUNG LEE, New Taipei (TW); CHIH-PING LO, New Taipei (TW)

(21) Appl. No.: 14/795,257

(22) Filed: Jul. 9, 2015

(30) Foreign Application Priority Data
Jun. 30, 2015 (CN) 201510374348.1

(51) Int. Cl. G06T 7/00; G06T 7/40; H04N 5/225

(52) U.S. Cl. CPC G06T 7/0008; H04N 5/2256; G06T 7/40; G06T 2207/30108; G06T 2207/30244; G06T 2207/10152

(57) ABSTRACT

A method for capturing images of different aspects of a test sample uses an electronic device. The electronic device is in communication with a detection device which provides a light source and a camera unit checking for surface flaws. A horizontal rotation platform of the detection device is controlled to locate to an initial position, and an inclination device of the detection device is controlled to locate to a horizontal position. The horizontal rotation platform rotates horizontally and the inclined device rotates vertically after activating the camera unit and the light source. The test sample is presented at different angles while images of the test sample are obtained.

### CROSS-REFERENCE TO RELATED APPLICATIONS

This application claims priority to Chinese Patent Application No. 201510374348.1 filed on Jun. 30, 2015, the contents of which are incorporated by reference herein.

### FIELD

The subject matter herein generally relates to image capturing and controlling.

### BACKGROUND

A testing sample (for example, a sample of a phone) can include surface flaws. Sometimes a surface flaw cannot be clearly or completely imaged under a fixed light source.

### BRIEF DESCRIPTION OF THE DRAWINGS

Many aspects of the disclosure can be better understood with reference to the following drawings. The components in the drawings are not necessarily drawn to scale, the emphasis instead being placed upon clearly illustrating the principles of the disclosure. Moreover, in the drawings, like reference numerals designate corresponding parts throughout the several views.

FIG. 1 is a block diagram of an example embodiment of an electronic device.

FIG. 2 is a diagrammatic view of an example embodiment of a detection device applied to the electronic device in FIG. 1.

FIG. 3 is a block diagram of an example embodiment of function modules of an image capturing system.

FIG. 4 is a flowchart of an example embodiment of a method for capturing an image using the electronic device.

### DETAILED DESCRIPTION

It will be appreciated that for simplicity and clarity of illustration, where appropriate, reference numerals have been repeated among the different figures to indicate corresponding or analogous elements. In addition, numerous specific details are set forth in order to provide a thorough understanding of the embodiments described herein. However, it will be understood by those of ordinary skill in the art that the embodiments described herein can be practiced without these specific details. In other instances, methods, procedures, and components have not been described in detail so as not to obscure the related relevant feature being described. Also, the description is not to be considered as limiting the scope of the embodiments described herein. The drawings are not necessarily to scale and the proportions of certain parts may be exaggerated to better illustrate details and features of the present disclosure.

The present disclosure, including the accompanying drawings, is illustrated by way of examples and not by way of limitation. It should be noted that references to “an” or “one” embodiment in this disclosure are not necessarily to the same embodiment, and such references mean “at least one.”

The term “module”, as used herein, refers to logic embodied in hardware or firmware, or to a collection of software instructions, written in a programming language, such as, Java, C, or assembly. One or more software instructions in the modules can be embedded in firmware, such as in an EPROM. The modules described herein can be implemented as either software and/or hardware modules and can be stored in any type of non-transitory computer-readable medium or other storage device. Some non-limiting examples of non-transitory computer-readable media include CDs, DVDs, BLU-RAY™, flash memory, and hard disk drives. The term “comprising” means “including, but not necessarily limited to”; it specifically indicates open-ended inclusion or membership in a so-described combination, group, series, and the like.

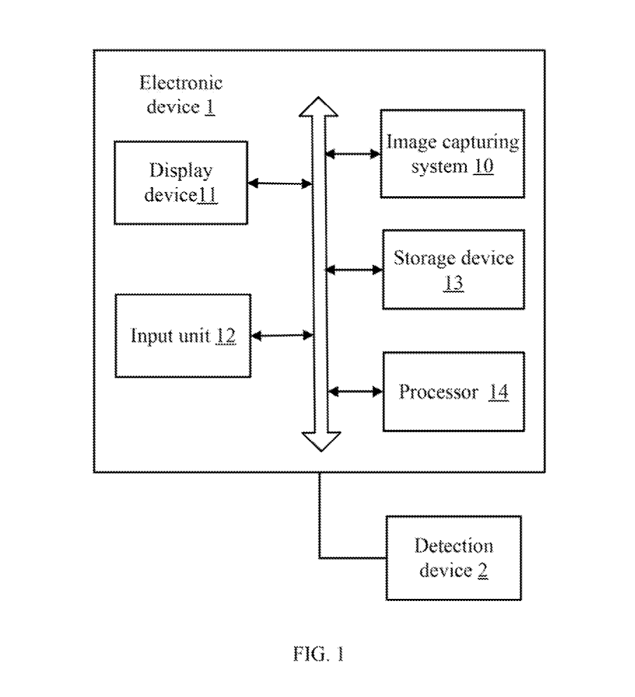

FIG. 1 is a block diagram of one embodiment of an electronic device. In one embodiment, the electronic device 1 may be a tablet computer, a notebook computer, or any other electronic device. The electronic device 1 includes, but is not limited to, an image capturing system 10, a display device 11, an input unit 12, a storage device 13, and at least one processor 14. The display device 11 displays data of the electronic device 1. The input unit 12 may be a mouse or a keyboard. FIG. 1 illustrates only one example of the electronic device, other examples can include more or fewer components than as illustrated, or have a different configuration of the various components in other embodiments.

In at least one embodiment, the storage device 13 can include various types of non-transitory computer-readable storage mediums. For example, the storage device 14 can be an internal storage system, such as a flash memory, a random access memory (RAM) for temporary storage of information, and/or a read-only memory (ROM) for permanent storage of information. The storage device 13 can also be an external storage system, such as a hard disk, a storage card, or a data storage medium. In at least one embodiment, the at least one processor 14 can be a central processing unit (CPU), a microprocessor, or other data processor chip that performs functions of the electronic device 1.

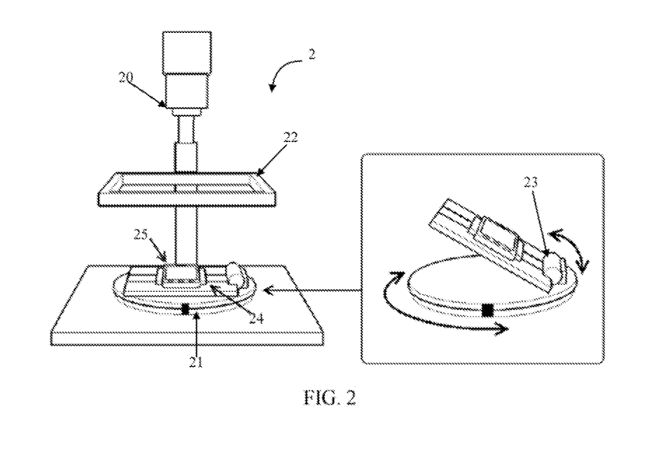

In at least one embodiment, the electronic device 1 interacts with a detection device 2 through a data cable (not shown). As shown in FIG. 2, the detection device 2 includes, but is not limited to, a camera unit 20, a horizontal rotating platform 21, a light source 22, and an inclination device 23. In at least one embodiment, the inclination device 23 is mounted on the horizontal rotation platform 42, one end of the inclination device 23 is fixed on the horizontal rotation platform 21, and the other end of the inclination device 23 is rotated vertically.

A fixed unit 24 is mounted on the inclination device 23. A sample under test (testing sample 25) is fixed on the fixed unit 24. The camera unit 20 is positioned directly above the testing sample 25. The light source 22 is positioned between the camera unit 20 and the testing sample 25. The testing sample 25 may be a mobile phone or other manufactured object. The horizontal rotation platform 21 includes a driving motor for rotating the horizontal rotation platform 21 and the inclination device 23, to adjust positions of the testing sample 25. The driving motor may be a stepper motor or a servo motor.

The image capturing system 10 can obtain images of the testing sample 25 in various positions as the horizontal rotation platform 21 and the inclination device 23 rotate.

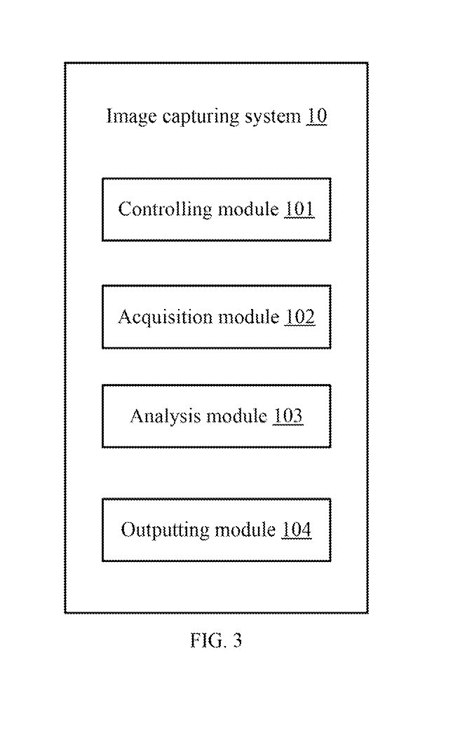

FIG. 3 is a block diagram of one embodiment of function modules of the image capturing system. In at least one embodiment, the image capturing system 10 can include a controlling module 101, an acquisition module 102, an analysis module 103, and an outputting module 104. The function modules 101, 102, 103, and 104 can include computerized codes in the form of one or more programs which are stored in the storage device 13. The at least one processor 14 executes the computerized codes to provide functions of the function modules 101-104.

The controlling module 101 can locate the horizontal rotation platform 21 in an initial position, and locate an inclination device 23 of the detection device 2 in a horizontal position. In one embodiment, the initial position is denoted as a zero starting position of the horizontal rotation platform 21, and the horizontal position is denoted as a zero angle position between the horizontal rotation platform 21 and the inclination device 23. When the horizontal rotation platform 21 is located at the initial position, the testing sample 25 is horizontal and fixed on the fixed unit 24.

The driving motor of the controlling module 101 can control the horizontal rotation platform 21 to rotate horizontally and control the inclination device 23 to rotate vertically after activating the camera unit 20 and the light source 22. The driving motor of the controlling module 101 can control the horizontal rotation platform 21 to rotate with a first predetermined angle (e.g., 1 degree), and control the inclination device 23 to rotate with a second predetermined angle (e.g., 70 degrees). For example, the driving motor of the controlling module 101 controls the inclination device 23 to rotate vertically from the horizontal position to the 70 degrees position, and controls the inclination device 23 to rotate vertically from the 70 degrees position to the horizontal position.

In one embodiment, the driving motor of the controlling module 101 can control the horizontal rotation platform 21 to rotate horizontally to a first position with a first predetermined angle (e.g., one degree). When the horizontal rotation platform 21 is in the first position, the driving motor of the controlling module 101 controls the inclination device 23 to rotate vertically from the horizontal position to a second predetermined angle position. When the inclination device 23 is in the second predetermined angle position, the driving motor of the controlling module 101 controls the horizontal rotation platform 21 to rotate horizontally to a second position with the first predetermined angle. When the horizontal rotation platform 21 is in the second position, the driving motor of the controlling module 101 controls the inclination device 23 to rotate vertically from the second predetermined angle position to the horizontal position again. The driving motor of the controlling module 101 repeatedly controls the horizontal rotation platform 21 to rotate horizontally, and controls the inclination device 23 to rotate vertically until the horizontal rotation platform 21 has executed a 360 degree rotation.

The camera unit 20 of the acquisition module 102 can obtain images of the testing sample 25 as the horizontal rotation platform 21 is rotated and the inclination device 23 is rotated. For example, when the horizontal rotation platform 21 is rotated in an increment of one degree, and the inclination device 23 is rotated in an increment of ten degree, the camera unit 20 captures two images of the testing sample 25.

The analysis module 103 can detect a surface flaw of each of the obtained images, and generate a result of detection, indicating a surface flaw or not. In one embodiment, the technology for detecting a surface flaw of each of the obtained images is existing technology, and details need not be given.

The outputting module 104 can output the result of detection to the display device 11, and sort the testing sample 25 according to the result of detection. In one embodiment, if none of the obtained images have any surface flaw the outputting module 104 can output the result that the testing sample 25 has no surface flaw, and sorts the testing sample 25 as a qualified product. The outputting module 104 can display information on the display device 11, for example, a word “Pass”. If one or more obtained images indicate surface flaws, the outputting module 104 can output the result that the testing sample 25 has the surface flaw, and sorts the testing sample 25 as unqualified. The outputting module 104 can display information on the display device 11, for example, a word “Failed.”

In other embodiments, the image capturing system 10 may be in the detection device 2. Alternatively some modules of the image capturing system 10 are run in the detection device 2 and other modules of the image capturing system 10 are run in the electronic device 1. For example, the modules of 101-102 are executed by a microprocessor of the detection device 2, and the modules of 103-104 are executed by the processor 14 of the electronic device 1.

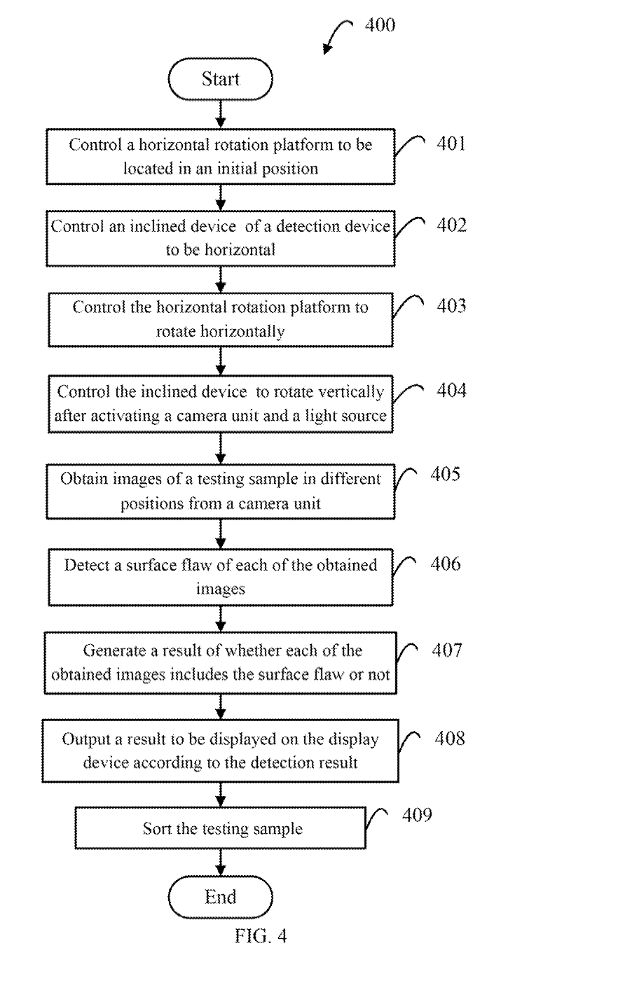

FIG. 4 illustrates a flowchart is presented in accordance with an example embodiment. An example method 400 is provided by way of example, as there are a variety of ways to carry out the method. The example method 400 described below can be carried out using the configurations illustrated in FIG. 1 and FIG. 3, and various elements of these figures are referenced in explaining the example method. Each block shown in FIG. 4 represents one or more processes, methods, or subroutines, carried out in the example method 400. Furthermore, the illustrated order of blocks is illustrative only and the order of the blocks can be changed. The example method 400 can begin at block 401. Depending on the embodiment, additional blocks can be utilized and the ordering of the blocks can be changed.

At block 401, a controlling module can control the horizontal rotation platform 21 to be located in an initial position. In one embodiment, the initial position is denoted as a zero starting position of the horizontal rotation platform 21. When the horizontal rotation platform 21 is located at the initial position, the testing sample 25 is positioned horizontally and fixed on the fixed unit 24.

At block 402, the controlling module further can control an inclination device 23 of the detection device 2 to be located horizontally.

At block 403, a driving motor of the controlling module can control the horizontal rotation platform 21 to rotate horizontally. In at least one embodiment, the driving motor of the controlling module can control the horizontal rotation platform 21 to rotate with a first predetermined angle (e.g., 1 degree).

At block 404, the driving motor of the controlling module further can control the inclination device 23 to rotate vertically after activating the camera unit 20 and the light source 22. In at least one embodiment, the driving motor of the controlling module control the inclination device 23 to rotate with a second predetermined angle (e.g., 70 degrees). For example, the driving motor of the controlling module 101 controls the inclination device 23 to rotate vertically from the horizontal position to the 70 degrees position, and controls the inclination device 23 to rotate vertically from the 70 degrees position to the horizontal position.

In one embodiment, the driving motor of the controlling module can control the horizontal rotation platform 21 to rotate horizontally to a first position with a first predetermined angle (e.g., one degree). When the horizontal rotation platform 21 is in the first position, the driving motor of the controlling module controls the inclination device 23 to rotate vertically from the horizontal position to a second predetermined angle position. When the inclination device 23 is in the second predetermined angle position, the driving motor of the controlling module controls the horizontal rotation platform 21 to rotate horizontally to a second position with the first predetermined angle. When the horizontal rotation platform 21 is in the second position, the driving motor of the controlling module controls the inclination device 23 to rotate vertically from the second predetermined angle position to the horizontal position again. The driving motor of the controlling module repeatedly controls the horizontal rotation platform 21 to rotate horizontally, and controls the inclination device 23 to rotate vertically until the horizontal rotation platform 21 has executed a 360 degree rotation.

At block 405, a camera unit 20 of an acquisition module can obtain images of the testing sample 25 as the horizontal rotation platform 21 is rotated and the inclination device 23 is rotated. For example, when the horizontal rotation platform 21 is rotated in an increment of one degree, and the inclination device 23 is rotated in an increment of ten degree, the camera unit 20 captures two images of the testing sample 25.

At block 406, an analysis module can detect a surface flaw of each of the obtained images. In one embodiment, the technology for detecting a surface flaw of each of the obtained images is existing technology, and details need not be given.

At block 407, the analysis module further can generate a result of detection, indicating a surface flaw or not.

At block 408, an outputting module can output the result of detection to the display device 11. In one embodiment, if none of the obtained images have any surface flaw, the outputting module can output the result that the testing sample 25 has no surface flaw. If one or more obtained images indicate surface flaws, the outputting module can output the result that the testing sample 25 has the surface flaw.

At block 409, the outputting module can sort the testing sample 25 according to the result of detection. When the testing sample 25 has no surface flaw, the outputting module can sort the testing sample 25 as a qualified product, and display information on the display device 11, for example, a word “Pass”. When the testing sample 25 has the surface flaw, the outputting module can sort the testing sample 25 as unqualified, and display information on the display device 11, for example, a word “Failed.”

It should be emphasized that the above-described embodiments of the present disclosure, including any particular embodiments, are merely possible examples of implementations, set forth for a clear understanding of the principles of the disclosure. Many variations and modifications can be made to the above-described embodiment(s) of the disclosure without departing substantially from the spirit and principles of the disclosure. All such modifications and variations are intended to be included herein within the scope of this disclosure and protected by the following claims.

What is claimed is:

1. An electronic device in communication with a detection device which provides a light source and a camera unit, the electronic device comprising:
at least one processor; and
a storage device coupled to the at least one processor and storing one or more programs, which when executed by the at least one processor, cause the at least one processor to:
control a horizontal rotation platform of the detection device to be located in an initial position;
control an inclination device of the detection device to be located horizontally;
control, after activating the camera unit and the light source, the horizontal rotation platform to rotate horizontally and the inclination device to rotate vertically; and
obtain images of the testing sample in different positions as the horizontal rotation platform is rotated and the inclined device is rotated.

2. The electronic device according to claim 1, wherein the at least one processor further:
detects surface flaws of the obtained images;
outputs a detection result that the testing sample has no surface flaw;
sorts the testing sample to a qualified product, when all of the obtained images have no surface flaw;
outputs a detection result that the testing sample has the surface flaw; and
sorts the testing sample to an unqualified product, when one or more obtained images have the surface flaws.

3. The electronic device according to claim 1, wherein the horizontal rotation platform and the inclination device are rotated by:
controlling the horizontal rotation platform to rotate horizontally to a first position with a first predetermined angle;
controlling the inclination device to rotate vertically from the horizontal position to second predetermined angle position when the horizontal rotation platform is in the first position;
controlling the horizontal rotation platform to rotate horizontally to a second position with the first predetermined angle when the inclination device is in the second predetermined angle position;
controlling the inclination device to rotate vertically from the second predetermined angle position to the horizontal position when the horizontal rotation platform is in the second position; and
repeatedly controlling the horizontal rotation platform to rotate horizontally, and controlling the inclination device to rotate vertically until the horizontal rotation platform was executed a 360 degree rotation.

4. The electronic device according to claim 3, wherein one end of the inclination device is fixed on the horizontal rotation platform and the other end of the inclination device is rotated vertically.

5. The electronic device according to claim 1, wherein a fixed unit of the detection device is fixed on the inclination device.

6. A computer-implemented method for capturing image using an electronic device, the electronic device in communication with a detection device which provides a light source and a camera unit, the method comprising:
controlling a horizontal rotation platform of the detection device to be located in an initial position;
controlling an inclination device of the detection device to be located horizontally;
controlling, after activating the camera unit and the light source, the horizontal rotation platform to rotate horizontally and the inclination device to rotate vertically; and
obtaining images of the testing sample in different positions as the horizontal rotation platform is rotated and the inclined device is rotated.

7. The method according to claim 6, further comprising:
detecting surface flaws of the obtained images;
outputting a detection result that the testing sample has no surface flaw;
sorting the testing sample to a qualified product, when all of the obtained images have no surface flaw;
outputting a detection result that the testing sample has the surface flaw; and
sorting the testing sample to an unqualified product, when one or more obtained images have the surface flaws.

8. The method according to claim 6, wherein the horizontal rotation platform and the inclination device are rotated by:
controlling the horizontal rotation platform to rotate horizontally to a first position with a first predetermined angle;
controlling the inclination device to rotate vertically from the horizontal position to second predetermined angle position when the horizontal rotation platform is in the first position;
controlling the horizontal rotation platform to rotate horizontally to a second position with the first predetermined angle when the inclination device is in the second predetermined angle position;
controlling the inclination device to rotate vertically from the second predetermined angle position to the horizontal position when the horizontal rotation platform is in the second position; and
repeatedly controlling the horizontal rotation platform to rotate horizontally, and controlling the inclination device to rotate vertically until the horizontal rotation platform was executed a 360 degree rotation.

9. The method according to claim 8, wherein one end of the inclination device is fixed on the horizontal rotation platform and the other end of the inclination device is rotated vertically.

10. The method according to claim 6, wherein a fixed unit of the detection device is fixed on the inclination device.

11. A non-transitory storage medium having stored thereon instructions that, when executed by a processor of an electronic device, causes the processor to perform a method for capturing image of a testing sample using the electronic device, the electronic device in communication with a detection device which provides a light source and a camera unit, the method comprising:
controlling a horizontal rotation platform of the detection device to be located in an initial position;
controlling an inclination device of the detection device to be located horizontally;
controlling, after activating the camera unit and the light source, the horizontal rotation platform to rotate horizontally and the inclination device to rotate vertically; and
obtaining images of the testing sample in different positions as the horizontal rotation platform is rotated and the inclined device is rotated.

12. The non-transitory storage medium according to claim 11, further comprising:
detecting surface flaws of the obtained images;
outputting a detection result that the testing sample has no surface flaw;
sorting the testing sample to a qualified product, when all of the obtained images have no surface flaw;
outputting a detection result that the testing sample has the surface flaw; and
sorting the testing sample to an unqualified product, when one or more obtained images have the surface flaws.

13. The non-transitory storage medium according to claim 11, wherein the horizontal rotation platform and the inclination device are rotated by:
controlling the horizontal rotation platform to rotate horizontally to a first position with a first predetermined angle;
controlling the horizontal rotation platform to rotate horizontally to a first position with a first predetermined angle;
controlling the inclination device to rotate vertically from the horizontal position to second predetermined angle position when the horizontal rotation platform is in the first position;
controlling the horizontal rotation platform to rotate horizontally to a second position with the first predetermined angle when the inclination device is in the second predetermined angle position;
controlling the inclination device to rotate vertically from the second predetermined angle position to the horizontal position when the horizontal rotation platform is in the second position; and
repeatedly controlling the horizontal rotation platform to rotate horizontally, and controlling the inclination device to rotate vertically until the horizontal rotation platform was executed a 360 degree rotation.

14. The non-transitory storage medium according to claim 13, wherein one end of the inclination device is fixed on the horizontal rotation platform and the other end of the inclination device is rotated vertically.

15. The non-transitory storage medium according to claim 11, wherein a fixed unit of the detection device is fixed on the inclination device.
